(19) United States
(12) Patent Application Publication
(10) Pub. No.: US 2012/0021291 A1
(43) Pub. Date: Jan. 26, 2012

(54) Method for Producing a Carbon Composite Material

(76) Inventors: Shan Ji, Bellville (ZA); Sivakumar Pasupathi, Bellville (ZA); Bernard Jan Blader-Groen, Bellville (ZA); Vladimir Mikhailovich Linkov, Bellville (ZA)

(21) Appl. No.: 13/127,338

(22) PCT Filed: Apr. 1, 2009
(86) PCT No.: PCT/IB09/51369

§ 371 Date: Oct. 12, 2011

(51) Int. Cl. H01M 4/525; H01M 4/583; B05D 5/12; B05D 3/02; B82Y 30/00

(52) U.S. Cl. 429/221; 427/122; 977/811

(57) ABSTRACT

The invention discloses a method for producing a carbon composite material, which includes the step of providing at least one carbon nanostructured composite material onto the surface of LiFePO4 particles to produce a LiFePO4/carbon nanostructured composite material. The carbon nanostructured composite material is obtained by synthesizing at least one nanostructured composite material to form the carbon nanostructured composite material.

### FIELD OF INVENTION

The present invention relates to a method for producing a carbon composite material.

More particularly, the present invention relates to a method for producing a carbon composite material, namely a high capacity LiFePO₄/nanostructured carbon composite such as a cathode electrode active material for large scale Li-ion batteries.

### BACKGROUND TO INVENTION

As the movement for environmental protection is increasingly dominant and the rapidly increasing price of oil is an undeniable reality, the automobile industry has been looking to introduce electric vehicles (EV), hybrid electric vehicles (HEV) and fuel cell vehicles (FCV), in place of conventional internal combustion vehicles as early as possible. In this regard, development of advanced batteries for application in transportation has become one of the top priorities due to the role of batteries as a critical technology for practical use of EV, HEV and FCV. Great strides in spreading battery powered vehicles and hybrid electric vehicles, through government programs and big companies, have been made in the USA, Japan, the European Union, Russia, India, China, Brazil, Norway, Iceland, and several other countries worldwide. All of these worldwide efforts are geared towards improving energy security and reducing environmental imbalances and improving their energy security. Li-ion secondary battery is at the forefront of battery technologies. Therefore, widely scoped usage of lithium ion battery in transportation will alleviate the dependence on petroleum.

LiCoO₂ is a conventional cathode material for lithium ion rechargeable batteries, which has been extensively applied as mobile power sources such as for mobile phones, camcorders, data cameras, laptops, media players and other portable data electronic devices. Recently it has been found that LiCoO₂ is not suitable for application as cathode materials in large sized lithium ion rechargeable batteries, such as electric vehicles (EV) and hybrid electric vehicles (HEV). In the large sized Li-ion battery, oxygen will release from LiCoO₂ crystal when the operation temperature is over 50° C. and results in safety issues. The extensive application of the lithium ion rechargeable battery is limited by the high cost of LiCoO₂. Lead-acid batteries are still provided to electric bicycles as mobile power sources, although high power or large capacity lithium ion rechargeable batteries have suitable performance to meet the standard. Therefore, it is necessary to find a suitable cathode material with lower price and higher performances, which is the key factor for lithium ion rechargeable batteries to be applied more extensively in EV and HEV. LiFePO₄ was one of the ideal cathode material candidates because of its low price, high specific energy density, and excellent safety, especially thermal stability at rather high temperature, providing safety to high power or large capacity batteries. However the capacity drops rapidly, because its conductivity is very poor, so polarization is easily observed during the course of charge-discharge.

There are two ways to improve its conductivity. One method is the introduction of a suitable element into the lattice, alternating the gap between the conduct and valence bands, by changing the energy gap. Another method was to introduce a conduct material into LiFePO₄ to improve its conductivity. Some progress has been made, but there are still some steps that need to be improved, since capacity decreases rapidly.

In order to improve the conductivity of LiFePO₄, much effort has been paid by many research groups worldwide.

LiFePO₄ coated with carbon was normally prepared via solid-state reaction, which required a long sintering time at 500-850° C. The carbon source could be sugar carbon gel, carbon black and aqueous gelatin, starch. It is obvious that these carbon sources didn't react with other precursors, which only decomposed and form carbon onto the surface of LiFePO₄ particles during sintering process. LiFePO₄/C composite electrode was synthesized by solid-state reaction of LiH₂PO₄ and FeC₂O₄ in the presence of carbon powder. The preparation was conducted under N₂ atmosphere through two heating steps. First, the precursors were mixed in stoichiometric ratio and sintered at 350-380° C. to decompose. Second, the resulting mixture was heated at high temperature to form crystalline LiFePO₄. The capacity of the resulting composite cathode increases with specific surface area of carbon powder. At room temperature and low current rate, the LiFePO₄/C composite electrode shows very high capacity—159 mAh/g. Unfortunately, the carbon formed on the surface of LiFePO₄ particle is not uniform, which has a negative effect on the electrochemical performance of this composite cathode at high rate.

US Patent Application 20020192197A1 discloses the fabrication of nano-sized and submicron particles of LiFePO₄ by a laser pyrolysis method. The synthesized LiFePO₄ showed a very good electrochemical performance, however, this method is a relatively expensive process, and the cathode material prepared by this method is not suitable for cost conscious applications, such as EV and HEV, where large amounts of cathode materials are required.

An in situ synthesis method for LiFePO₄/C materials has been developed using cheap FePO₄ as an iron source and polypropylene as a reductive agent and carbon source. XRD and SEM showed that LiFePO₄/C prepared by this method forms fine particles and homogeneous carbon coating. The electrochemical performances of the LiFePO₄/C were evaluated by galvanostatic charge/discharge and cyclic voltammetry measurements. The results shown that the LiFePO₄/C composite had a high capacity of 164 mAh/g at 0.1 C rate, and possessed a favourable capacity cycling maintenance at the 0.3 and 0.5 C rates. But the electrochemical performance of this LiFePO₄ /C composite is not very good at high rate due to non-uniform carbon coating formed on the surface of LiFePO₄.

The synthesizing of nano-sized LiFePO₄ composite and conductive carbon by two different methods is known, which results in enhancement of electrochemical performance. In a first method, a composite of phosphate with a carbon xerogel was formed from resorcinol-formaldehyde precursor. In a second method, surface oxidized carbon particles were used as nucleating agent for phosphate growth. It was found that electrochemical performance of composite synthesized by method one were better because of the intimate contact of carbon with LiFePO₄ particle. The capacity of resulting LiFePO₄/C composite is up to 90% theoretical capacity at 0.2 C. However, xerogels and aerogels have poor packing density, which will lead to low volumetric density of large-sized Li-ion secondary battery.

It is an object of the invention to suggest a method for producing a carbon composite material which will assist in overcoming the afore-mentioned problems.

### SUMMARY OF INVENTION

According to the invention, a method for producing a carbon composite material includes the step of providing at least one carbon nanostructured composite material onto the surface of LiFePO4 particles to produce a LiFePO4/carbon nanostructured composite material.

Also according to the invention, a carbon composite material includes a LiFePO4/nanostructured composite material having at least one carbon nanostructured composite material provided onto the surface of LiFePO4 particles.

Yet further according to the invention, a Li-ion secondary battery includes a carbon composite material having a LiFePO4/nanostructured composite material having at least one carbon nanostructured composite material provided onto the surface of LiFePO4 particles.

The carbon nanostructured composite material may be obtained by synthesizing at least one nanostructured composite material to form the carbon nanostructured composite material.

The method may occur in a solid-state reaction.

The nanostructured composite material may have a high electric conductivity.

Ni salt may be used as a catalyst in the step of synthesizing the nanostructured composite material to form the carbon nanostructured composite material.

The Ni salt may be reduced at high temperature.

Hydrocarbon gas may be used as a carbon source in the step of synthesizing the nanostructured composite material to form the carbon nanostructured composite material.

The method may include the step of synthesizing the nanostructured composite material by means of a mist Ni solution as Ni source and gaseous carbon sources to form the carbon nanostructured composite material.

The step of providing at least one carbon nanostructured composite material onto the surface of LiFePO4 particles to produce a LiFePO4/carbon nanostructured composite material may occur at a high temperature.

The carbon composite material may be a cathode electrode active material with a high capacity.

The carbon composite material may be used in a Li-ion secondary battery.

### BRIEF DESCRIPTION OF DRAWINGS

The invention will now be described by way of example with reference to the accompanying schematic drawings.

In the drawings there is shown in:

FIG. 1: XRD of LiFePO₄/NCM;

FIG. 2: TEM of LiFePO₄/NCM made from Example 1;

FIG. 3: TEM of LiFePO₄/NCM made from Example 2; and

FIG. 4: Cycle life of LiFePO₄/CNT and LiFePO₄/C at various rates.

### DETAILED DESCRIPTION OF DRAWINGS

The invention provides cathode electrode active materials with high capacity, methods to prepare the same, and cathode and a Li-ion secondary battery employing the same. A new LiFePO₄/nanostructured carbon materials (NCM) composite cathode electrode was prepared via a solid-state reaction, in which high electric conductive NCM were grown on the surface of LiFePO₄ particles. Battery cathodes include a current collector and cathode materials coated on the current collector, said cathode materials including a cathode active materials based on LiFePO₄/NCM, conductive additive and binder. The binder has excellent binding force and elasticity, which results in high uniform cathode for lithium secondary battery. The cathodes based on LiFePO₄/NCM manufactured by this invention have improved assembly density, high capacity and high energy density. The performances of LiFePO₄ modified by NCM are superior to that of LiFePO₄ without NCM in terms of both high-rate (1 C) and cycle life. The results showed that LiFePO₄ modified by NCM is efficient way to manufacture high-power Li-ion secondary batteries.

The present invention focuses on developing new method and easily scalable processes for fabricating LiFePO₄/NCM composite electrode materials. Olivine LiFePO₄ is one of the most promising cathode candidates for lithium ion batteries, especially in electric vehicles, hybrid electric vehicles. LiFePO₄ has attracted more and more attention because of its low cost, high cycle life, high energy density and environmental benignity. Unfortunately, its low intrinsic electric conductivity and low electrochemical diffusion are huge obstacles for its extensive applications. When the LiFePO₄ are charged and discharge at high rates, the capacity drops very quickly. Currently, two main methods are reported to improve its electric conductivity. One is to coat carbon on the surface of LiFePO₄; another is dope other metal ions into the crystal lattice of LiFePO₄. The former was identified to improve its conductivity, but this method only improved the conductivity between these grains, which had not really improved the intrinsic electric conductivity. And the latter method by doping metal supervalent ions could not completely avoid the overgrowth of single crystal when calcining. Due to diffusion limitation, poor electrochemical performance is resulted from larger crystal.

NCM, such as carbon fibers, carbon nanotubes, has excellent electric conductivity in the axe direction. For example, there are many free and mobile electrons available on the surface of carbon nanotubes. Carbon fiber has been used to improve the high-power performances of LiFePO₄ cathode. In this invention, LiFePO₄/NCM composite electrodes was prepared by synthesizing NCM on the surface of LiFePO₄ when LiFePO₄ was formed at high temperature. These composite electrodes showed better electrochemical performance at high discharge. The composite electrode retained high specific capacity at high discharge rate.

The first aspect of the invention is directed to fabricate LiFePO₄/NCM composite using Ni salt reduced at high temperature as catalyst and hydrocarbon gas as the only carbon source, which has some advantages such as easily control, NCM grown on the surface of LiFePO₄ particles, improved electronic conductivity, low cost, and cathode materials with high power density.

The second aspect of this invention is to synthesize carbon NCM via using mist Ni solution as Ni source and gaseous carbon sources, to improve the electrochemical performance of LiFePO₄/NCM composite.

LiFePO₄/NCM composite cathode materials with high capacity and high power density can be mass-produced, based on the existing equipment for manufacturing LiFePO₄. This invention could be easily upscaled to industrial scale.

Electron exchange occurs simultaneously in the electrode of Li-ion secondary battery when it is charged and discharged. Mobility of Li-ions and electrons is critical to cathode active materials. Unfortunately, LiFePO₄, as a promising cathode material, is a very poor with regards to electronic conductivity, which is about 10⁻⁹ S/cm. In order to improve the electronic conductivity of LiFePO₄, methods of surfacing coating and lattice doping were widely adopted. Normally, the carbon-coating was an efficient way to improve electronic conductivity. Solid carbon sources, such as acetylene black, sugar, starch, sucrose and glucose, were widely used to synthesize LiFePO₄/C composite in the literature. However, a homogeneously coated carbon is not easily to form on the particles of LiFePO₄ due to its small size and porous structure. NCM, such as carbon nanotubes, is a nanostructured form of carbon in which the carbon atoms are in graphitic sheets rolled into a seamless cylinder with a hollow core. The unique arrangement of the carbon atoms in carbon nanotubes gives rise to the thigh thermal and electrical conductivity, excellent mechanical properties and relatively good chemical stability. NCM have many advantages over conventional amorphous carbon used in LiFePO₄/C electrode materials, such as high conductivity, tubular shape. It is reported that electronic conductivity of carbon nanotubes was around 1-4*10² S/cm along the nanotube axis. Meanwhile, the conductivity between the LiFePO₄ particles can be improved by NCM because NCM can connect separated LiFePO₄ particles together. The conducting connections between the neighboring particles will be improved when NCM are introduced in cathode electrode materials.

In the present invention, gaseous carbon sources and Ni salts reduced at high temperature are used as catalyst to synthesize NCM and were adopted to synthesize high electronic conductive LiFePO₄/NCM materials.

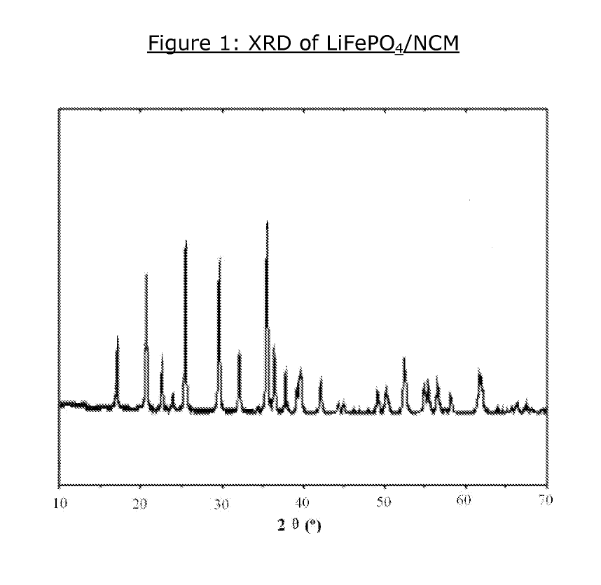

After introduction of catalysts for NCM, the LiFePO₄ also forms olive structure shown in FIG. 1. The NCM and present of catalysts have no effect on the formation of LiFePO₄. This present invention relates to improved electrochemical performance of LiFePO₄/NCM cathode materials and includes the following steps:
1) Precursors of Fe, Li, phosphate and additives were ball-milled with a stoichiometric ratio. The resulting mixture was sintered at 350-380° C. for 0.5-5 hr to decompose. Then, the mixture was calcined to form crystalline LiFePO₄ at the temperature range from 500° C. to 900° C. for 1-24 hours.
2) After the crystalline LiFePO₄ was formed in the high temperature furnace, hydrocarbon gaseous carbon source for synthesizing NCM, such as liquid petrol gases (LPG), ethylene, benzene, propylene, methyl benzene, was introduced into the high temperature furnace at high temperature (650-1000° C.) for 10-200 min, to form NCM on the surface of LiFePO₄.
3) Meanwhile, the NCM can be grown before the LiFePO₄ was formed at high temperature. In this case, precursors of Fe, Li, phosphate and catalysts were ball-milled with a stoichiometric ratio and sintered at 650-1000° C. Then, gaseous carbon resource was introduced into furnace for 5-100 min. After that, the resulting mixture was calcined to form crystalline LiFePO₄ at the temperature range from 500° C. to 900° C. for 1-24 hours.
4) The LiFePO₄/NCM synthesized from Step 2 and Step 3 was mixed with acetylene black, PVDF in NMP to form slurry, which was cast onto an Al foil. The electrodes were dried and pressed using a hydraulic press. Li-ion secondary cells were assembled with anode and electrolyte, in which separator was soaked in 1.0 mol·L⁻¹ LiPF₆/EC+DMC [EC:DMC=1:1] solution. The cells were assembled in an argon protected glove box.

In the step of 1), wherein: additives could be Ni, Fe, Cr and Ti particles.

In the step of 4), wherein: weight ratio of LiFePO₄, acetylene blank or NCM and PVDF is 60-95:5-25:5-20)

Optimizing schemes include the following:

In the step of (1), wherein: the resulting mixture was calcined to form crystalline LiFePO₄ at 700-800° C.

In the step of (1), wherein: the solid state reaction time of formation of LiFePO₄ is 20-26 hours.

In the step of (2), wherein: the optimized temperature for formation NCM on the surface of LiFePO₄ is 700-950° C.

In the step of (4), wherein: acetylene black content in electrode having a weight ratio in a range from 5% to 10%.

In the step of (4), wherein: PVDF content in electrode having a weight ratio in a range from 1% to 20%.

### Example 1

The LiFePO₄/NCM was prepared via in-situ chemical vapour deposit method to form NCM on the surface of LiFePO₄ particles with gaseous hydrocarbon as carbon sources. The preparation was carried out through two sintering steps under N₂ atmosphere to make sure Fe²⁺ formed in LiFePO₄/NCM composite. Li₂CO₃, NH₄H₂PO₄, and FeC₂O₄.2H₂O were mixed and ball-milled. A dispersing liquid, such as alcohol, was added to form slurry which was ground for 6 hours through combined shaking and rotation actions. After milled, the mixed slurry was dried to evaporate the alcohol in vacuum oven at 50° C. Then, the mixture was put into a furnace and nitrogen was introduced at the flow rate of 10-100 ml/min and the temperature began to rise to the set temperature at the rate of 10-30° C./min. The mixture was first calcined at 350-380° C. for 0.5-8 hrs, then the temperature was increased to 750° C. After the mixture was kept at this temperature for 15-20 hrs, a Ni mist was introduced to the furnace. The mist was produced from a 0.1˜2.0 M Ni solution (mixture of NiCl₂ and NiSO₄). The argon gas flow was turned off and ethylene as well as hydrogen gas where simultaneously introduced into the furnace at a flow rate of 100 ml/min each for 90 minutes. After the time elapsed the final product was cooled to room temperature under the argon atmosphere.

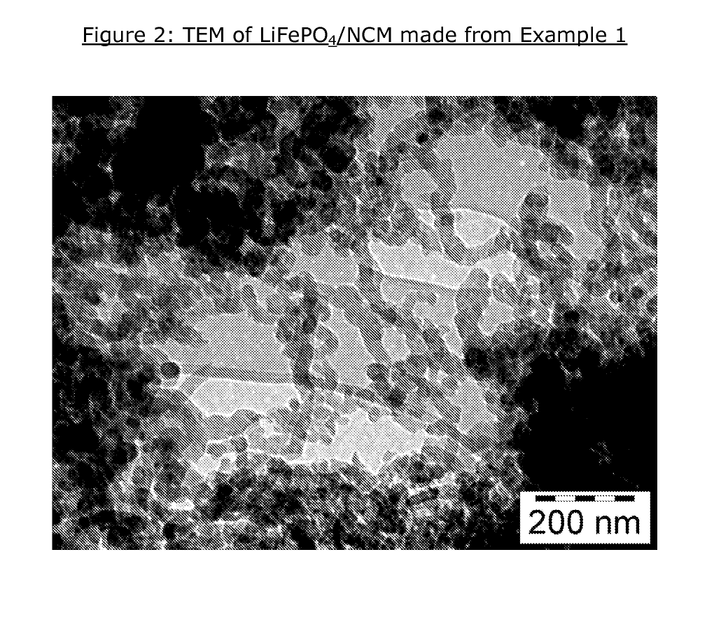

TEM was used to observe the morphology of the compound (FIG. 2). The positive electrode consisted of 80% of LiFePO₄/NCM, 10% acetylene black and 10% Polyvinylidene Fluoride (PVDF) as a binder, and metal Al metal was used as the collector. The electrolyte solution was 1.0 mol·L⁻¹ LiPF₆/EC+DMC[V(EC):V(DMC)=1:1]. Lithium metal foil was used as the counter electrode during electrochemical measurements. All cells were assembled in an argon-filled glovebox. And the charge/discharge properties of as-prepare composites were test in the BT2000.

### Example 2

Li₂CO₃, NH₄H₂PO₄ and FeC₂O₄.2H₂O were mixed and ball-milled. A dispersing liquid, alcohol was added to form slurry which was ground for 6 hours through combined shaking and rotation actions. After milled, the is mixed slurry was dried to evaporate the alcohol in vacuum oven at 50° C. Then, the mixture was put in furnace and nitrogen was introduced at the flow rate of 50 ml/min and the temperature began to rise to the set temperature at the rate of 30° C./min. When it arrived at the set point of 650-1000° C., the liquid petroleum gas was introduced into the tubular oven at the flow rate of 20 ml/min for 5-60 minutes. After that, the precursors were calcined at 500-900° C. under the nitrogen atmosphere for another 10-23 h. The product was cool down to room temperature under nitrogen atmosphere.

The synthesized LiFePO₄ was mixed with Ni salt via slurry method and drying under vacuum at 60° C. The salts can be NiSO₄, NiCl₂ and Ni(NO₃)₂. In this example, the NiSO₄/LiFePO₄ composite powder was placed onto a crucible and put into the furnace. The NCM growth was attempted at 800° C. using 100 ml/min flow rates of ethylene and hydrogen gas concurrently.

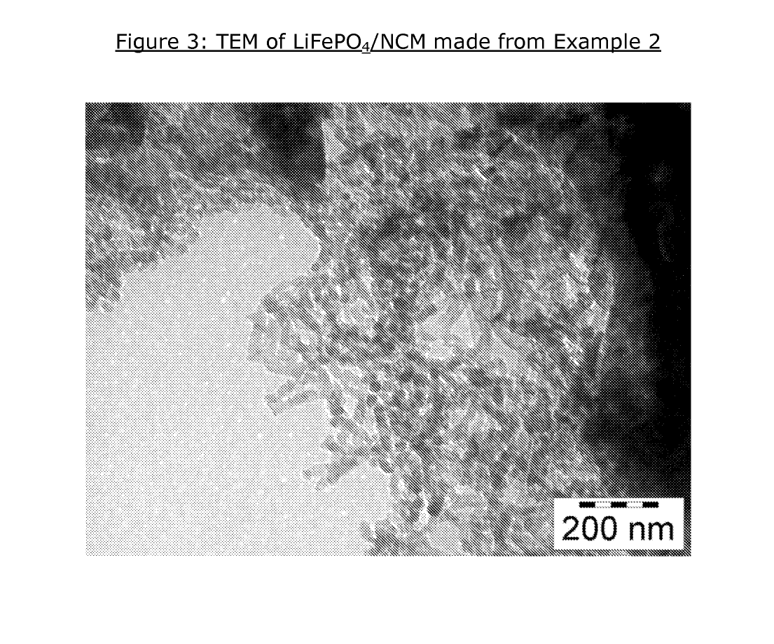

The synthesized LiFePO₄/NCM was characterized by TEM (FIG. 3). The positive electrode consisted of 80% of LiFePO₄-NCM, 10% acetylene black and 10% Polyvinylidene Fluoride (PVDF) as a binder, and metal Al metal was used as the collector. The electrolyte solution was 1.0 mol·L⁻¹ LiPF₆/EC+DMC[V(EC):V(DMC)=1:1]. Lithium metal foil was used as the counter electrode during electrochemical measurements. All cells were assembled in an argon-filled glovebox. And the charge/discharge properties of as-prepare composites were test in the BT2000.

### Example 3

Li₂CO₃, NH₄H₂PO₄, Ni particles and FeC₂O₄.2H₂O were mixed and ball-milled by ZrO₂ balls in a planetary micro mill. A dispersing liquid, alcohol was added to form slurry which was ground for 6 hours through combined shaking and rotation actions. After milled, the mixed slurry was dried to evaporate the alcohol in vacuum oven at 50° C. Then, the mixture was put in furnace and nitrogen was introduced at the flow rate of 50 ml/min and the temperature began to rise to the set temperature at the rate of 30° C./min. When it arrived at the set point of 650-1000° C., a Ni mist was introduced to the furnace. The mist was produced from a 0.1˜2.0 M Ni solution (mixture of NiCl₂ and NiSO₄). The argon gas flow was turned off and ethylene as well as hydrogen gas where simultaneously introduced into the furnace at a flow rate of 100 ml/min each for 90 minutes. After that, the precursors were calcined at 500-900° C. under the nitrogen atmosphere for another 10-23 h. The product was cool down to room temperature under nitrogen atmosphere.

The synthesized LiFePO₄/NCM was characterized by TEM. The positive electrode consisted of 80% of LiFePO₄-NCM, 10% acetylene black and 10% Polyvinylidene Fluoride (PVDF) as a binder, and metal Al metal was used as the collector. The electrolyte solution was 1.0 mol·L⁻¹ LiPF₆/EC+DMC[V(EC):V(DMC)=1:1]. Lithium metal foil was used as the counter electrode during electrochemical measurements. All cells were assembled in an argon-filled glovebox. And the charge/discharge properties of as-prepare composites were test in the BT2000.

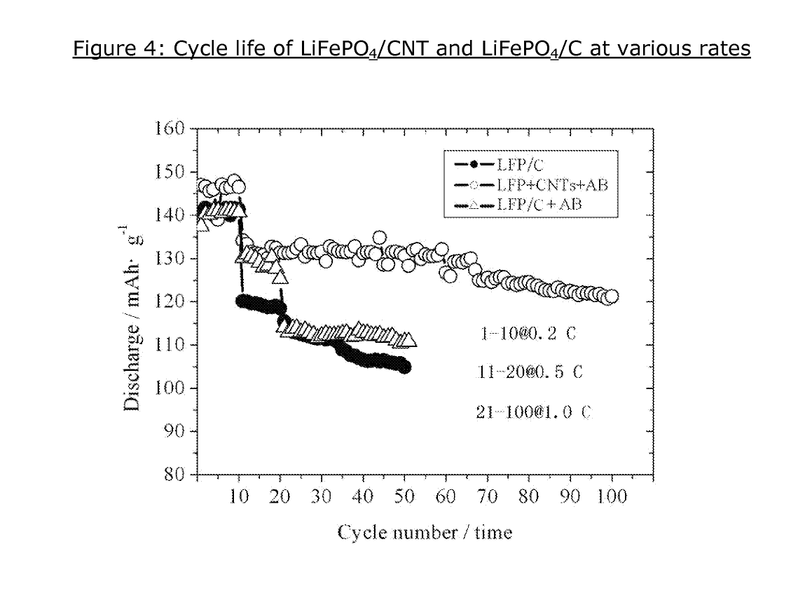

Charge-discharge performances of LiFePO₄/NCM and LiFePO₄/C were compared in FIG. 4. In the LiFePO₄/NCM, the LiFePO₄/C particles were dispersed in the network of NCM. Therefore, electrons can be transmitted to these electrochemical reaction sites, where Fe²⁺ changed to Fe³⁺ reversibly. The cycle performances of LiFePO₄/NCM and LiFePO₄/C were shown in FIG. 4. It can be observed that LiFePO₄/NCM exhibited much higher discharge capacity and much excellent cycle stability at different discharge currents. The discharge capacity decreased sharply for the conventional LiFePO₄/C, especially at 1 C discharge rate.

1. A method for producing a carbon composite material, which includes the steps:
(a) of growing at least one carbon nanostructured material onto the surface of LiFePO₄ particles to produce a LiFePO₄/carbon nanostructured composite cathode material by using Ni and/or Co salts as catalyst and hydrocarbon gas as carbon source; and
(b) of synthesizing carbon nanostructured composite material on the LiFePO₄/carbon nanostructured composite cathode material by using mist Ni solution as Ni source and gaseous carbon sources.

2. (canceled)

3. A method as claimed in claim 1, which occurs in a solid-state reaction.

4. A method as claimed in claim 1, in which the carbon nanostructured composite cathode material has a high electric conductivity and/or capacity.

5. (canceled)

6. A method as claimed in claim 1, in which the Ni and/or Co salts are reduced at high temperature.

7-8. (canceled)

9. A method as claimed in claim 2, which includes a heating temperature in the range of 500-900° C.

10. A method as claimed in claim 1, which includes a synthesizing time for the carbon nanostructured composite cathode material after gaseous carbon source is introduced which is in the range of 1-360 mins.

11. A method as claimed in claim 1, in which metal powder, such as Ni, Fe, Co and alloy, is used as metallic catalysts for synthesizing the carbon nanostructured material on the surface of LiFePO₄ particles.

12. A method as claimed in claim 11, in which the metallic catalysts are doped into a crystal lattice of LiFePO₄ during heat treatment.

13-14. (canceled)

15. A method as claimed in claim 1, in which the carbon composite material is used in a Li-ion secondary battery.

16. A carbon composite material, which includes:
(a) LiFePO₄/carbon nanostructured composite cathode material synthesized by at least one carbon nanostructured material grown onto the surface of LiFePO₄ particles by using Ni and/or Co salts as catalyst and hydrocarbon gas as carbon source; and
(b) carbon nanostructured composite material synthesized on the LiFePO₄/carbon nanostructured composite cathode material by using mist Ni solution as Ni source and gaseous carbon sources.

17-18. (canceled)

19. A carbon nanostructured material as claimed in claim 16, which is used in a Li-ion secondary battery.
